(19) United States
(12) Patent Application Publication
(10) Pub. No.: US 2011/0181002 A1
(43) Pub. Date: Jul. 28, 2011

(54) WATERPROOFING MEMBER FOR TERMINAL PROVIDED FOR ELECTRONIC DEVICE

(75) Inventors: Shinji FUJITA, Osaka (JP); Minoru MUKOUDA, Hyogo (JP); Tetsuyuki WATANABE, Osaka (JP); Hideki HARADA, Osaka (JP)

(73) Assignee: PANASONIC CORPORATION, Osaka (JP)

(21) Appl. No.: 13/009,217

(22) Filed: Jan. 19, 2011

(30) Foreign Application Priority Data
Jan. 25, 2010 (JP) 2010-013330
Apr. 28, 2010 (JP) 2010-103994

(51) Int. Cl. H02G 15/04

(52) U.S. Cl. 277/616

(57) ABSTRACT

A rib 7b is provided in the vicinity of a power terminal portion 7 of a first enclosure 1 and a waterproofing member 11 is fitted to the rib 7b and an AC adaptor 10 to render the power terminal portion 7 waterproof. Since there is no need to change the outside shape of the AC adaptor 10, a waterproof structure can be achieved without incurring a significant cost increase. Furthermore, because a conventional AC adaptor can be used, the waterproofing member excels in general versatility.

### BACKGROUND OF INVENTION

1. Field of the Invention

The present application relates to a waterproofing member for a terminal provided for an electronic device.

2. Description of Related Art

Conventionally, in order to improve the practical utility of electronic devices, waterproof connection means are developed. The connection means render electronic devices waterproof even when peripheral devices are connected to them. These connection means not only reduce the risk of electronic device and peripheral device failures resulting from liquid spillage or the like but also allows the use of electronic devices in an unfavorable outdoor environment such as in the rain. For this reason, the range in which they can be used is broadening. A typical example of such connection means is a waterproofing connector.

JP S60-243891 A discloses a connection device in which a cylindrical body is provided in a through hole that penetrates a waterproof case via a gasket. When connecting a plug provided at the tip of a cable to a device body stored in the waterproof case, a hook portion provided on a plug cover covering the plug engages with a groove formed on the exterior of the cylindrical body.

With the configuration disclosed in JP S60-243891 A, however, it is necessary to provide the plug with a rib used for positioning the plug cover. Therefore, waterproofing becomes inadequate when a typical plug without a rib is connected to the jack.

Furthermore, the configuration disclosed in JP S60-243891 A requires the plug cover, the cylindrical body (plug guide) and the gasket in order to render the periphery of the jack of the waterproof case waterproof. Thus, a large number of components are needed in this configuration, which leads to a cost increase.

Further, since the configuration disclosed in JP S60-243891 A uses a large number of components, attachment/detachment of the plug to/from the jack involves complexity. More specifically, when connecting the plug to the jack, it is necessary to, first, insert the plug into the jack, then, attach the cylindrical body to the waterproof case cabinet with the packing therebetween, and finally, attach the plug cover to the cylindrical body. When disconnecting the plug from the jack, the opposite steps need to be performed. In this way, attachment/detachment of the plug to/from the jack becomes complex.

### SUMMARY OF THE INVENTION

Viewed from one aspect, the waterproofing member of the present application is a waterproofing member attachable to a connection area in which a terminal is connected to a connection port. The waterproofing member includes a first bump portion that is erected seamlessly and can come into contact with a periphery of the terminal; a second bump portion that can come into contact with the connection port; and a through hole through which the connection port can be passed. When the terminal is connected to the connection port, the waterproofing member conceals the terminal and the second bump portion is in intimate contact with the connection port.

Viewed from another aspect, the waterproofing member of the present application is a waterproofing member attachable to and detachable from a concave portion formed in the vicinity of a connection port to which a terminal provided for a cable is connected. The waterproofing member includes a first waterproofing member that includes a first hole through which the terminal can be passed and can be press-fitted to the concave portion; and a second waterproofing member that includes a second hole through which the cable can be passed and can be press-fitted to the first hole. By passing the cable through the first hole, press-fitting the first waterproofing member to the second hole and press-fitting the second waterproofing member to the concave portion, the second waterproofing member and the concave portion come into intimate contact with each other, the first waterproofing member and the second waterproofing member come into intimate contact with each other, and the first waterproofing member and the cable come into intimate contact with each other.

### BRIEF DESCRIPTION OF THE DRAWINGS

FIG. 1 is a perspective view of a notebook computer as an exemplary electronic device.

FIG. 2 is a plan view of principal parts of the notebook computer as an exemplary electronic device.

FIG. 3A is a plan view of a waterproofing member.

FIG. 3B is a cross-sectional view of a Z-Z portion in FIG. 3A.

FIG. 4 is a cross-sectional view showing a state where an AC adaptor and the waterproofing member are connected to a power terminal portion.

FIG. 5 is a cross-sectional view showing a modified example of the waterproofing member.

FIG. 6 is a perspective view showing a modified example of the waterproofing member.

FIG. 7 is a perspective view of a notebook computer, a USB cable and a waterproofing member.

FIG. 8A is a perspective view of the USB cable and the waterproofing member.

FIG. 8B is a perspective view of the USB cable and the waterproofing member.

FIG. 9 is a cross-sectional view showing a state where the USB cable and the waterproofing member are connected to the notebook computer.

FIG. 10 is a cross-sectional view showing a state where a waterproofing member with another structure is connected to the power terminal portion.

FIG. 11 is a cross-sectional view showing a state where a waterproofing member with another structure is connected to the power terminal portion.

FIG. 12 is a cross-sectional view showing a state where a waterproofing member with another structure is connected to the power terminal portion.

FIG. 13 is a perspective view of a notebook computer as an exemplary electronic device.

FIG. 14A is a plan view of a first waterproofing member.

FIG. 14B is a cross-sectional view of a Z-Z portion in FIG. 14A.

FIG. 15A is a plan view of a second waterproofing member.

FIG. 15B is a cross-sectional view of a Z-Z portion in FIG. 15A.

FIG. 16A is a perspective view showing a state before passing a LAN cable through the second waterproofing member.

FIG. 16B is a perspective view showing a state after passing the LAN cable through the second waterproofing member.

FIG. 16C is a perspective view showing a state where the first waterproofing member is held on the cable.

FIG. 17 is a cross-sectional view showing a state where the LAN cable and the waterproofing member are attached to the notebook computer.

FIG. 18 is a cross-sectional view showing a modified example of the first waterproofing member.

FIG. 19 is a cross-sectional view showing a modified example of the waterproofing member.

FIG. 20 is a cross-sectional view showing a modified example of the second waterproofing member.

FIG. 21 is a cross-sectional view showing a modified example of the first waterproofing member.

FIG. 22 is a side view showing a modified example of the second waterproofing member.

FIG. 23 is a cross-sectional view showing a state where the LAN cable and the waterproofing member (modified example) are attached to the notebook computer.

### DETAILED DESCRIPTION OF EMBODIMENTS

### Embodiment 1

### 1. Configuration of Electronic Device and Connection Device

Hereinafter, a description will be given of an embodiment where a notebook computer is taken as an exemplary electronic device to which the waterproofing member of the present application is applied.

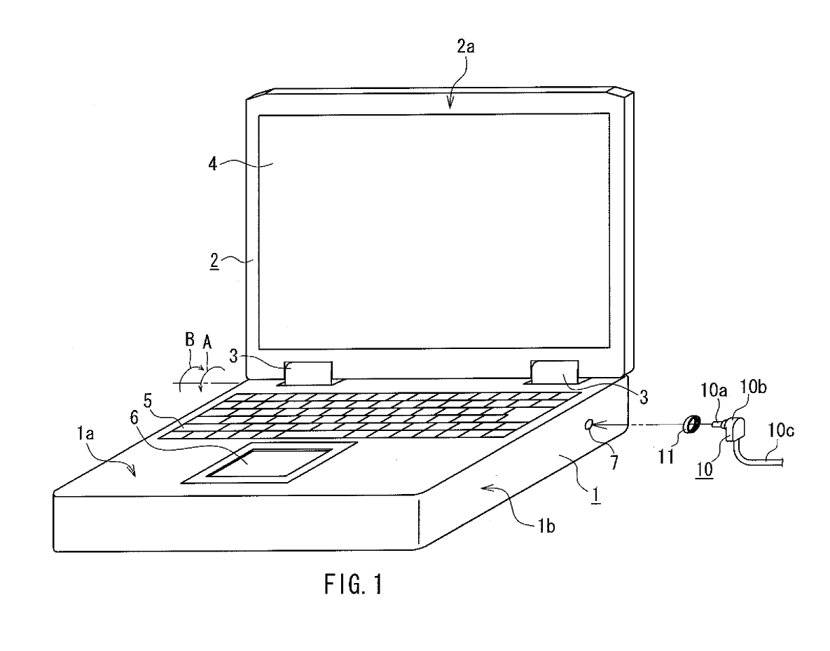

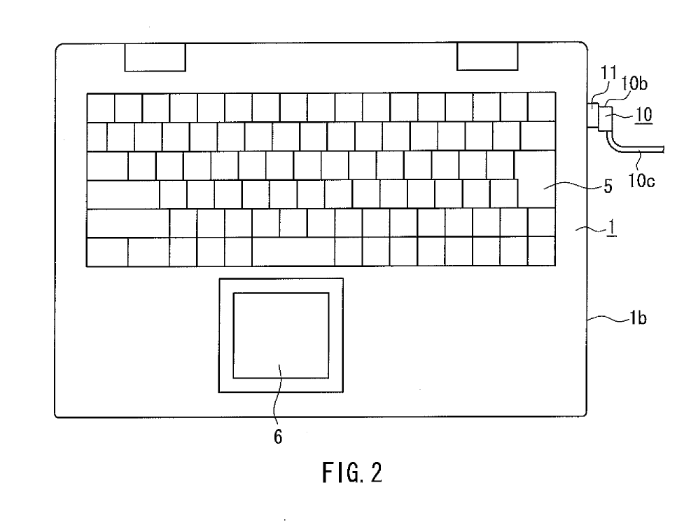

FIG. 1 is a perspective view showing the appearance of the notebook computer according to the present embodiment. FIG. 2 is a plan view of principle parts of the notebook computer according to the present embodiment. FIG. 1 shows a state prior to connecting the connection device to the notebook computer and FIG. 2 shows a state where the connection device is connected to the notebook computer.

Although a notebook computer is taken as an exemplary electronic device in the present embodiment; it can be any electronic device to which at least a connection device, such as any of various cables, can be connected. In addition to a notebook computer, examples of such electronic devices include a mobile phone terminal, a portable music player, a digital camera, a camcorder, and a portable game machine, which can be used in the outdoors and to which a connection device can be connected. Examples of connection devices include those in the form of a cable, such as a power cable, a network cable and a headphone cable, and those in the form of a unit, such as a memory unit that can be connected to a USB (Universal Serial Bus) terminal. The form of a connection device is not limited.

As shown in FIG. 1, the notebook computer includes a first enclosure 1 and a second enclosure 2. The first enclosure 1 includes a circuit board on which a variety of electronic components are mounted, a hard disk drive and the like. The second enclosure 2 includes a display 4 (e.g., liquid crystal display). Each of the first enclosure 1 and the second enclosure 2 is supported rotatably by hinges 3. The hinges 3 each include a rotation shaft for rotatably supporting the first enclosure 1 and the second enclosure 2.

A keyboard 5 and a pointing device 6 are provided on a top face la of the first enclosure 1. A user types in a variety of characters with the keyboard 5. The pointing device 6 is a device operable to accept a touch operation performed by the user on its operating surface and to move a cursor displayed on the display 4 to a desired position.

A power terminal portion 7 is provided on a side face lb of the first enclosure 1. An AC adapter 10 can be connected to the power terminal portion 7. Power can be supplied to the power terminal portion 7 through the AC adaptor 10.

The AC adaptor 10 can be connected to the power terminal portion 7 in a connection area. Attachment of a waterproofing member 11 to the connection area renders the connection area waterproof. By attaching the waterproofing member to the connection area between the AC adapter 10 and the power terminal portion 7, it is possible to prevent the entry of a liquid or the like into the first enclosure 1 through the power terminal portion 7. The AC adaptor 10 can be connected electrically to the power terminal portion 7 without attaching the waterproofing member 11. In that case, however, a liquid or like may enter the first enclosure 1 through the power terminal portion 7. The AC adaptor 10 does not have a special shape for achieving a waterproof structure (e.g., the rib disclosed in JP S60-243891 A). The AC adaptor 10 includes a terminal 10a, a sheath portion 10b and a cable 10c. The terminal 10a has a substantially cylindrical shape and has at least, at its tip, a hole in/to which an electric contact 7a (described later) included in the power terminal portion 7 can be inserted/electrically connected. The sheath portion 10b is made of an insulating material such as a resin and electrically sheathes part of conducting wires (not shown) running in the cable 10c. A user can hold the sheath portion 10b when attaching/detaching the AC adaptor 10 to/from the power terminal portion 7. The sheath portion 10b is made of a hard material in the present embodiment. As for the cable 10c, its one end is connected electrically to the terminal 10a and the other end is connected electrically to a plug (not shown) connectable to a power source, for example.

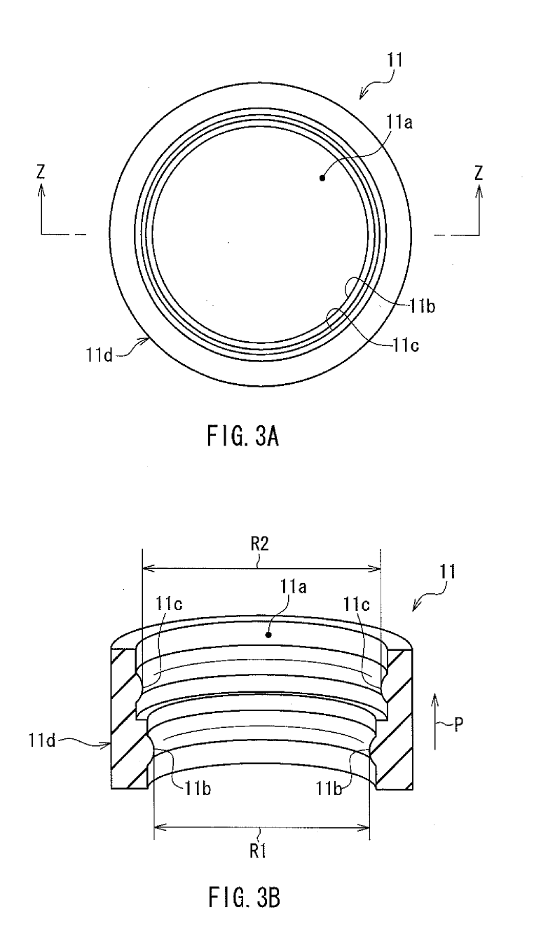

The waterproofing member 11 has a shape as shown in FIGS. 3A and 3B. FIG. 3A is a plan view of the waterproofing member 11. FIG. 3B is a cross-sectional view of the Z-Z portion in FIG. 3A. As shown in FIGS. 3A and 3B, the waterproofing member 11 includes a hollow portion 11a and has a substantially cylindrical shape. The waterproofing member 11 is preferably made of a soft material and is made of a soft resin material in the present embodiment. A first bump portion 11b and a second bump portion 11c are formed on the inner surface of the waterproofing member 11. Each of the first bump portion 11b and the second bump portion 12 is formed throughout the inner surface of the waterproofing member 11 in the circumference direction. Note that the entire waterproofing member 11 does not have to be made of a soft material as long as the first bump portion 11b and the second bump portion 11c are soft. In FIG. 3B, R1 denotes the inside diameter of the first bump portion 11b and R2 denotes the inside diameter of the second bump portion 11c.

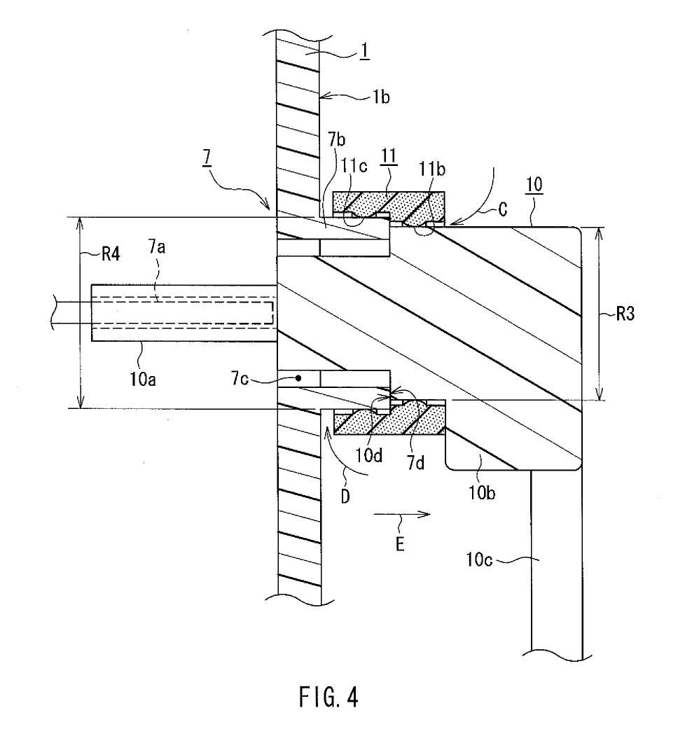

FIG. 4 is a cross-sectional view of principal parts in the vicinity of the power terminal portion 7 when the AC adaptor 10 is connected to the power terminal portion 7. As shown in FIG. 4, the power terminal portion 7 includes the electric contact 7a, a rib 7b and a hole 7c. The electric contact 7a is a contact in the form of a pin, which can be inserted into and electrically connected to the terminal 10a of the AC adaptor 10. The rib 7b has a substantially cylindrical shape and is erected around the hole 7c through which the terminal 10a is passed. In the present embodiment, the rib 7b is formed integrally with the first enclosure 1 and is made of a hard material.

The AC adaptor 10 is connected to the power terminal portion 7 as follows. First, the terminal 10a is passed through the hollow portion 11a of the waterproofing member 11. As shown in FIG. 3B, the terminal 10a is passed through the waterproofing member 11 from the opening on the first bump portion 11b side in the direction indicated by the arrow P. At this time, as shown in FIG. 4, the sheath portion 10b is fitted to the first bump portion 11b of the waterproofing member 11. Since the inside diameter R1 of the first bump portion 11b (see FIG. 3B) and the outside diameter R3 of the sheath portion 10b (see FIG. 4) have the relationship R1<R3, the sheath portion 10b presses and deforms the first bump portion 11b whereby the sheath portion 10b is press-fitted to the waterproofing member 11. Also, the first bump portion 11b and the sheath portion 10b come into intimate contact with each other.

Next, the terminal 10a is inserted into the hole 7c to connect the terminal 10a to the electric contact 7a. At this time, an end 10d of the sheath portion 10b of the AC adaptor 10 is preferably brought into contact with an end 7d of the rib 7b because the AC adaptor 10 can be situated at the position where the electric contact 7a and the terminal 10a can be connected to each other with certainty. As a result, the AC adaptor 10 and the power terminal portion 7 are connected to each other electrically. By connecting the AC adaptor 10 to the power terminal portion 7 in the manner described above, the waterproofing member 11 is fitted to the rib 7b. Since the inside diameter R2 of the second bump portion 11c of the waterproofing member 11 (see FIG. 3B) and the outside diameter R4 of the rib 7b have the relationship R2<R4, the rib 7b presses and deforms the second bump portion 11c whereby the rib 7bis press-fitted to the second bump portion 11c. That is, the second bump portion 11c and the rib 7b come into intimate contact with each other. Consequently, the waterproofing member 11 is fitted to the rib 7b and to the sheath portion 10b.

Furthermore, since the first bump portion 11b is formed throughout the inner surface of the waterproofing member 11 in the circumference direction and the first bump portion 11b and the sheath portion 10b are in intimate contact with each other, the entry of a liquid into the first enclosure 1 through a gap between the waterproofing member 11 and the sheath portion 10b can be prevented (the entry of a liquid in the direction indicated by the arrow C in FIG. 4 can be stopped). Furthermore, since the second bump portion 11c is formed throughout the inner surface of the waterproofing member 11 in the circumference direction and the second bump portion 11c and the rib 7b are in intimate contact with each other, the entry of a liquid into the first enclosure 1 through a gap between the waterproofing member 11 and the rib 7b can be prevented (the entry of a liquid in the direction indicated by the arrow D in FIG. 4 can be stopped).

The AC adaptor 10 is removed from the power terminal portion 7 as follows. First, the waterproofing member 11 and the AC adaptor 10 are moved in the direction indicated by the arrow E from the position shown in FIG. 4 by holding the waterproofing member 11. As a result of moving the AC adaptor 10 to a position where the second bump portion 11c is detached from the rib 7b and the terminal 10a is detached from the electric contact 7a, the electric connection between the AC adaptor 10 and the power terminal portion 7 is released.

The waterproofing member 11 that has been detached from the rib 7b together with the AC adaptor 10 may remain fitted to the sheath portion 10b of the AC adaptor 10. Also, the waterproofing member 11 may be detached from the sheath portion 10b (displacing it in the opposite direction to the arrow E direction in FIG. 4) to detach it from the AC adaptor 10. The waterproofing member 11 also may be moved further in the direction indicated by the arrow E from the position where it is fitted to the sheath portion 10b in FIG. 4 so that it is fitted freely to the cable 10c. When the waterproofing member 11 is freely fitted to the cable 10c, the waterproofing member 11 is not removed easily from the AC adaptor 10, so that a loss of the waterproofing member 11 can be prevented.

In the above, although the waterproofing member 11 and the AC adaptor 10 are detached from the power terminal portion 7 by moving them in the direction indicated by the arrow E at the same time, they can be detached from the power terminal portion 7 by first moving the waterproofing member 11 in the direction indicated by the arrow E, and then moving the adapter 10 in the direction indicated by the arrow E.

### 2. Effects of Embodiment, Etc.

According to the present embodiment, the waterproof structure is achieved by providing the rib 7b in the vicinity of the power terminal portion 7 of the first enclosure 1 and fitting the waterproofing member 11 to the rib 7b and to the AC adaptor 10. Because there is no need to change the outside shape of the AC adaptor 10, the waterproof structure can be achieved without incurring a significant cost increase. Furthermore, since a conventional AC adaptor can be used, the waterproofing member according to the present embodiment excels in general versatility

Further, because the waterproofing member 11 is the only component needed to achieve the waterproof structure, it can be obtained at low cost. Moreover, since the number of components is small, the AC adaptor 10 easily can be attached to and detached from the power terminal portion 7.

As for the waterproofing member 11, the first bump portion 11b comes into sliding contact with the AC adaptor 10 and the second bump portion 11c comes into sliding contact with the rib 7b provided on the first enclosure 1. Thus, in comparison with the case of connecting the AC adaptor 10 to the first enclosure 1 alone, they are connected to each other with friction resulting from the first bump portion 11b and the second bump portion 11c of the waterproofing member 11. Because the strength of the connection between the AC adaptor 10 and the first enclosure 1 can be enhanced by the friction, it is possible to prevent accidental detachment of the AC adaptor 10 even if a user accidentally touches it. Further, when connecting the AC adaptor 10 to the first enclosure 1, a user can detect both the friction resulting from the first bump portion 11b coming into slide contact with the AC adaptor 10 and the friction resulting from the second bump portion 11c coming into slide contact with the rib 7b, so that the certainty of the connection can also be improved.

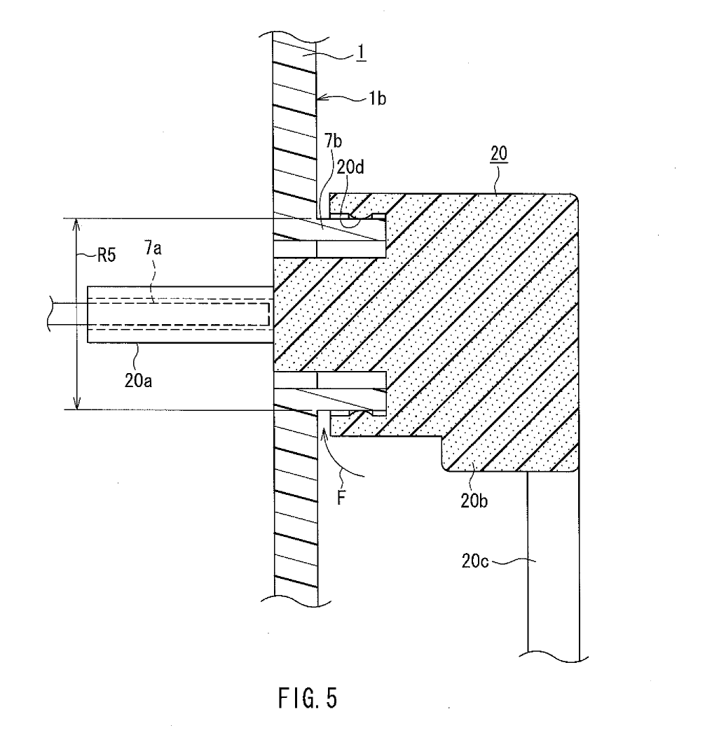

Although the AC adaptor 10 and the waterproofing member 11 are provided separately in the present embodiment, they can be integrated into one piece. FIG. 5 is a cross-sectional view showing a configuration of an AC adaptor 20 integral with a waterproofing member. In FIG. 5, the same components as those shown in FIG. 4 are denoted by the same reference numerals and the detailed descriptions thereof will not be repeated. The AC adaptor 20 shown in FIG. 5 is provided with a bump portion 20d on the sheath portion 20b on the terminal 20a side. The bump portion 20d is formed throughout the inner surface of the sheath portion 20b in the circumference direction. The bump portion 20d, together with the sheath portion 20b, is made of an elastically deformable resin material. As shown in FIG. 5, by connecting the AC adaptor 20 to the power terminal portion 7, the bump portion 20d comes into contact with the external cylindrical surface of the rib 7b. At that time, because the inside diameter R5 of the bump portion 20d and the outside diameter R4 of the rib 7b (see FIG. 4) have the relationship R5<R4, the rib 7b presses and deforms the bump portion 20d whereby the rib 7b is press-fitted to the bump portion 20d. In other words, the bump portion 20d and the rib 7b come into intimate contact with each other. Consequently, the sheath portion 20b is attached to the rib 7b with certainty. Further, since the bump portion 20d and the rib 7b are in intimate contact with each other, the entry of a liquid into the first enclosure 1 through a gap between the sheath portion 20b and the rib 7b can be prevented (the entry of a liquid in the direction indicated by the arrow F in FIG. 5 can be stopped). Moreover; by integrating the bump portion 20d and the sheath portion 20b in one piece, the number of components can be reduced further. Since the adaptor shown in FIG. 5 needs to be changed in its outer shape, its general versatility deteriorates. But still, the number of components is smaller than that in the configuration disclosed in JP S60-243891 A, so that its ease of attachment to and detachment from an electronic device is excellent. Further, since there is slide contact friction that acts between the bump portion 20d and the rib 7b, the strength of the connection can be enhanced and the certainty during the connection can be improved similarly to the configuration described above.

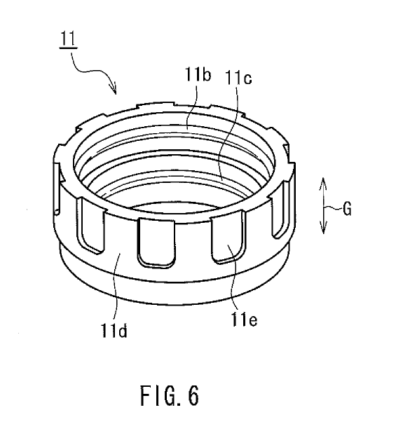

As shown in FIG. 6, the waterproofing member 11 is preferably provided with a plurality of concave portions 11e on the external cylindrical surface 11d (see FIGS. 3A and 3B). As a result, when a user holds the external cylindrical surface 11d with the fingers to attach/detach the waterproofing member 11 to/from the AC adaptor 10 and the rib 7b, slipping of the fingers can be lessened, and the ease of attachment/detachment of the waterproofing member 11 can be improved. Further, by forming the concave portions lie so as not to extend completely along the external cylindrical surface 11d in the width direction (direction indicated by the arrow G) but only on the first bump portion 11b side, a user can comprehend the orientation of the waterproofing member 11 visually or by touch. Hence, the waterproofing member 11 can be attached to the AC adaptor 10 or the rib 7b in the correct position (orientation).

Although the waterproofing member 11 is made of a soft material and the rib 7b and the sheath portion 10 are made of a hard material in the present embodiment, the waterproofing member 11 may be made of a hard material and the rib 7b and the sheath portion 10b may be made of a soft material.

Further, as shown in FIGS. 3B and 4, the first bump portion 11b and the second bump portion 11c in the present embodiment have an arc-like cross-section so that the surfaces that respectively come into contact with the rib 7b and the sheath portion 10b have an arc-shape. This is for dispersing a pressure applied to the first bump portion 11b and to the second bump portion 11c when fitting the waterproofing member 11 to the rib 7b and the sheath portion 10b. Consequently, it is possible to ease the wearing away of the tips of the first bump portion 11b and the second bump portion 11c resulting from attaching/detaching the waterproofing member 11 repeatedly, so that deterioration of the waterproofing ability and the ability to be held on the AC adaptor 10 can be prevented even when it is used for a long period of time.

Further, because the waterproofing member 11 includes the first bump portion 11b and the second bump portion 11c that have different inside diameters from each other, its attachment direction to the rib 7b and the AC adaptor 10 is fixed. Therefore, by putting a mark on the external cylindrical surface 11d of the waterproofing member 11 to notify a user of the right attachment direction, improper attachment can be prevented. Instead of putting a mark, a tiny bump may be formed only on the external cylindrical surface 11d on the first bump portion 11b side.

Further, although the waterproofing member 11 is press-fitted to the rib 7b and to the sheath portion 10b in the present embodiment, it may be screwed to at least one of them. In this case, it is preferable to form a male screw on the waterproofing member 11 in the area corresponding to the first bump portion 11b and to form a female screw on the sheath portion 10b in terms of effectively attaching/detaching the AC adaptor 10 and the waterproofing member 11 to the power terminal portion 7. Even when the waterproofing member 11 is screwed to the AC adaptor 10, it is necessary to bring the AC adaptor 10 and the waterproofing member 11 into intimate contact with each other at the screwed portion in order to stop the entry of water with certainty.

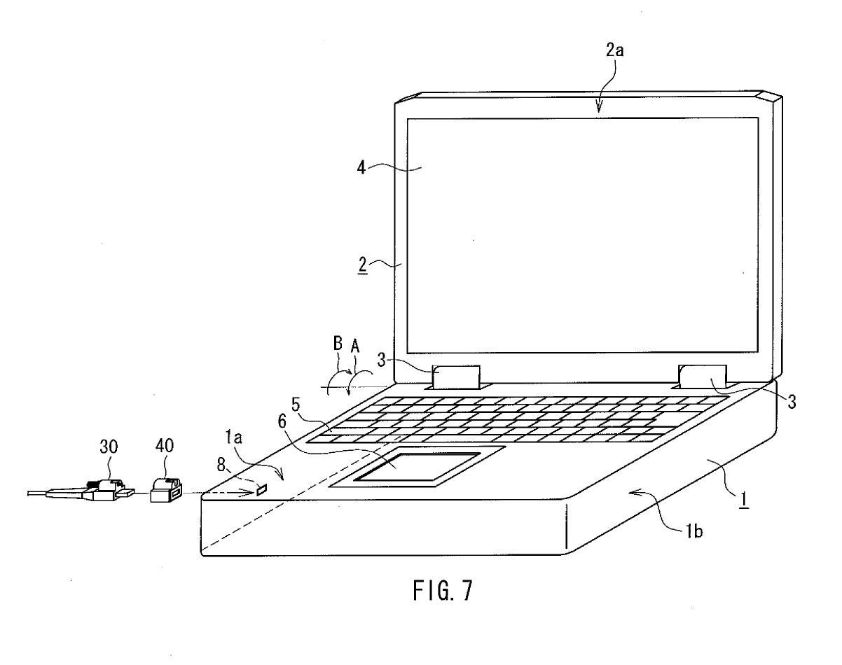

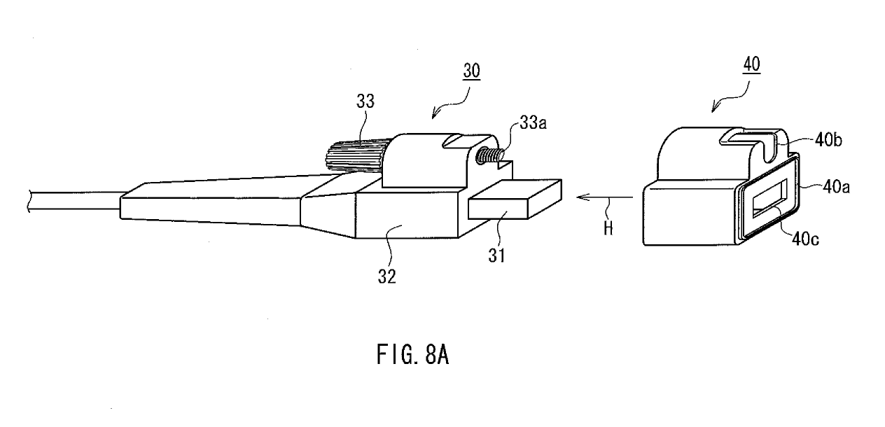

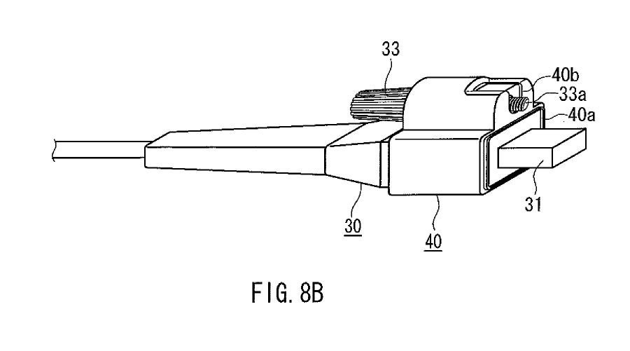

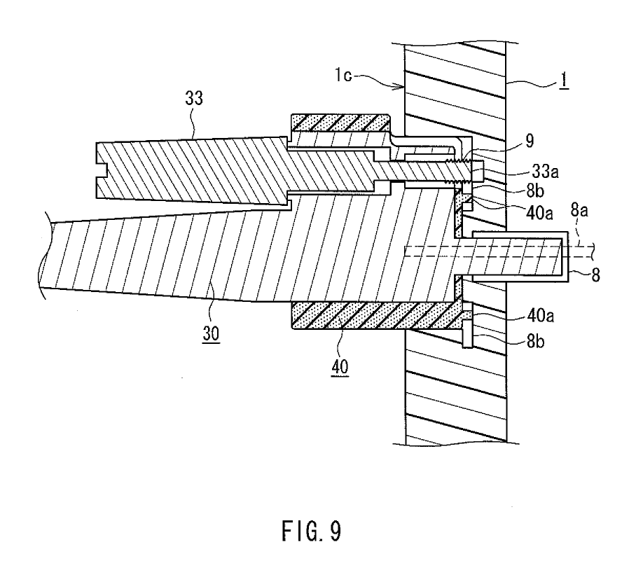

Further, although an AC adaptor is taken as an exemplary connection device in the present embodiment, the waterproofing member can also be applied to other connection devices. The connection device may be a USB cable. FIG. 7 is a perspective view of the notebook computer, a USB cable 30 and a waterproofing member 40. FIG. 8A is a perspective view of the USB cable 30 and the waterproofing member 40 before connecting one to the other. FIG. 8B is a perspective view of the USB cable 30 and the waterproofing member 40 that are connected to each other. FIG. 9 is a cross-sectional view of a state where the USB cable 30 is connected to the notebook computer. As shown in FIG. 7, a USB port 8 is provided on a side face 1c of the first enclosure 1 of the notebook computer. The side face 1c is a side face opposing the side face 1b. Further, as shown in FIG. 9, a screw hole 9 is formed in the vicinity of the USB port 8 of the first enclosure 1. As shown in FIG. 8A, the USB cable 30 includes a USB terminal 31, a sheath portion 32 and a screw 33. The USB terminal 31 can be connected to the USB port 8 (see FIGS. 7 and 9). The sheath portion 32 sheathes internal wiring (not shown). The screw 33 is disposed such that its male screw portion 33a sticks out in the same direction as the USB terminal 31 via a through hole formed in a part of the sheath portion 32. Similarly to the waterproofing member 11 of the present embodiment, the waterproofing member 40 is preferably made of a soft material. The waterproofing member 40 includes a first hole 40b through which the male screw portion 33a of the screw 33 can be passed, a second hole 40c through which the USB terminal 31 can be passed and a third bump portion 40a erected around the hole 40c. As shown in FIG. 9, the third bump portion 40a comes into contact or intimate contact with a surrounding surface 8b of the USB port 8 of the first enclosure 1 when the waterproofing member 40 is attached to the USB cable 30 and the USB terminal 31 is inserted in the USB port 8. Furthermore, as shown in FIG. 9, by screwing the screw 33 into the screw hole 9, the third bump portion 40a is sandwiched between the sheath portion 32 of the USB cable 30 and the surrounding surface 8b of the USB port 8, so that it comes into intimate contact with the surrounding surface 8b of the USB port 8. As a result of such a configuration, the entry of a liquid into the USB port 8 can be prevented when the USB terminal 31 is connected to the USB port 8.

In the present embodiment, although the connection between the USB terminal 31 and the USB port 8 is made certain by screwing the screw 33 into the screw hole 9, the following can be applied to an ordinary USB terminal without the screw 33, for example. That is, a bump portion (hereinafter referred to as a new bump portion) is further provided on the face of the waterproofing member 40 opposing the USB cable at a position from which the state of insertion of the USB terminal 31 into the USB port 8 can be detected. As a result of such a configuration, the certainty of the waterproofness of the third bump portion 40a can be confirmed visually. The position from which the insertion of the USB terminal 31 into the USB port 8 can be detected can be either a position where a side face of the new bump portion on the USB terminal 31 side comes into contact with the side face 1c of the first enclosure 1 or a position where the new bump portion slidably comes into contact with a side wall included in the first enclosure 1 in the direction in which the USB cable 30 is inserted into the USB port 8.

Further, as shown in FIG. 3B or the like, the first bump portion 11b and the second bump portion 11c are formed on the hollow portion 11a of the waterproofing member 11 in the present embodiment. However, positions on which the bump portions are formed are not limited to on the hollow portion 11a.

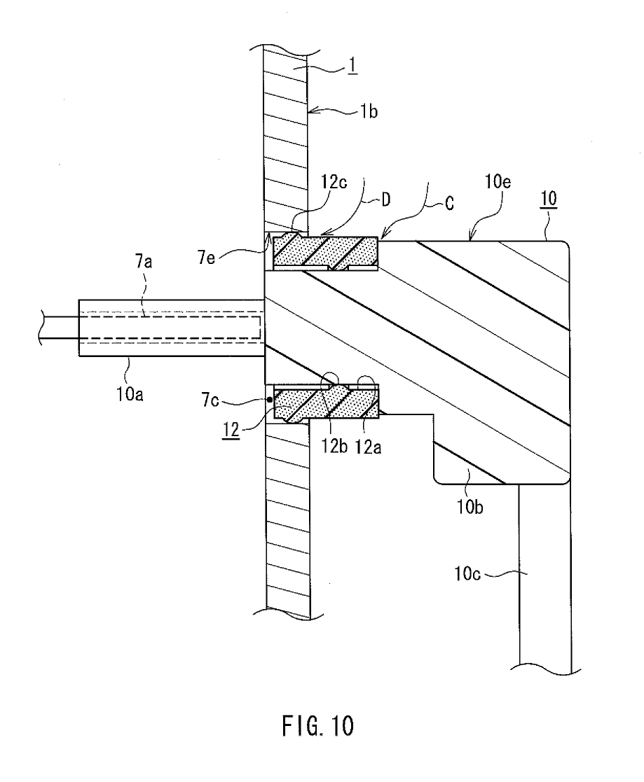

FIG. 10 shows an example where one of the two bump portions is formed on the external cylindrical surface of a waterproofing member. In FIG. 10, the same components as those shown in FIG. 4 are denoted by the same reference numerals and the detailed descriptions thereof will not be repeated. Similarly to the waterproofing member 11 shown in FIG. 4, a waterproofing member 12 shown in FIG. 10 is made of a soft material and is formed in a substantially cylindrical shape. Referring to the waterproofing member 12, a first bump portion 12b is formed on a hollow portion 12a and a second bump portion 12c is formed on the external cylindrical surface of the waterproofing member 12. In the state where the AC adaptor 10 is passed through the hollow portion 12a, the first bump portion 12b can come in contact with the cylinder portion 10b of the AC adaptor 10 or the cylinder portion 10b can be press-fitted to the first bump portion 12b. The second bump portion 12c is situated in the hole 7c and can come into contact with an inner surface 7e of the hole 7c or can be press-fitted to the hole 7c. As shown in FIG. 10, by press-fitting the AC adaptor 10 to the hollow portion 12a of the waterproofing member 12 and press-fitting the waterproofing member 12 to the hole 7c, the entry of a liquid in the direction indicated by the arrow C can be stopped by the first bump portion 12b. Also, the entry of a liquid in the direction indicated by the arrow D can be stopped by the second bump portion 12c. Consequently, the same effects as those of the present embodiment can be achieved. Furthermore, with the configuration shown in FIG. 10, there is no need to form a rib on the first enclosure 1, so that the configuration for allowing the attachment of the waterproofing member can be achieved without changing the shape of the first enclosure 1. It is preferable that the second bump portion 12c shown in FIG. 10 is formed at the position that can come into contact with the inner surface 7e when the end of the waterproofing member 12 in the cylindrical axis direction is brought into contact with the cable 10c of the AC adaptor 10. As a result of such a configuration, the waterproofing member 12 can be positioned easily and with certainty at a place where waterproofing can be achieved. However, it is not necessary to bring the waterproofing member 12 into contact with the cable 10c as long as the first bump portion 12b and the second bump portion 12c are respectively provided at the positions where the first bump portion 12b comes into contact with the cylinder portion 10 and the second bump portion 12c comes into contact with the inner surface 7e.

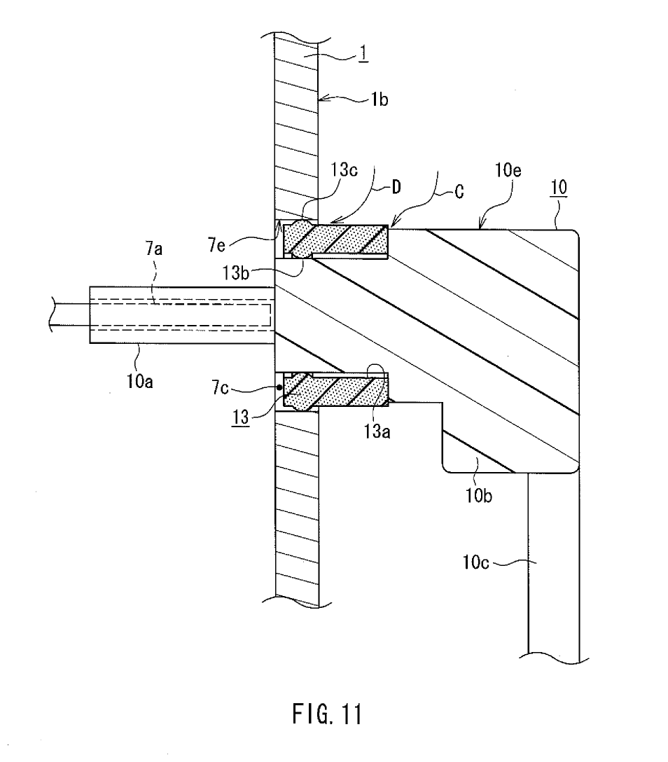

FIG. 11 shows an example where a first bump portion on the hollow portion and a second bump portion on the external cylindrical surface are formed at the positions that coincide with each other in the direction perpendicular to the cylindrical axis of the waterproofing member. In FIG. 11, the same components as those shown in FIG. 10 are denoted by the same reference numerals and the detailed descriptions thereof will not be repeated. Similarly to the waterproofing member 12 shown in FIG. 10, a waterproofing member 13 shown in FIG. 11 is made of a soft material and is formed in a substantially cylindrical shape. Referring to the waterproofing member 13, a first bump portion 13b is formed on a hollow portion 13a and a second bump portion 13c is formed on the external cylindrical surface of the waterproofing member 13. The first bump portion 13b and the second bump portion 13c are formed at the positions that coincide with each other in the direction perpendicular to the cylindrical axis of the waterproofing member 13. In the state where the AC adaptor 10 is passed through the hollow portion 13a, the first bump portion 13b can come into contact with the cylinder portion 10b of the AC adaptor 10 or the cylinder portion 10b can be press-fitted to the first bump portion 13b. The second bump portion 13c is situated in the hole 7c and can come into contact with the inner surface 7e of the hole 7c or can be press-fitted to the hole 7c. As shown in FIG. 11, by press-fitting the AC adaptor 10 to the hollow portion 13a of the waterproofing member 13 and press-fitting the waterproofing member 13 to the hole 7c, the entry of a liquid in the direction indicated by the arrow C can be stopped by the first bump portion 13b. Also, the entry of a liquid in the direction indicated by the arrow D can be stopped by the second bump portion 13c. Consequently, the same effects as those of the present embodiment can be achieved. Furthermore, with the configuration shown in FIG. 11, there is no need to form a rib on the first enclosure 1, so that the configuration for allowing the attachment of the waterproofing member can be achieved without changing the shape of the first enclosure 1.

In the configuration shown in FIG. 11, it is preferable that the first bump portion 13b and the second bump portion 13c are formed at substantially the center of the waterproofing member 13 in the axial direction. As a result of such a configuration, even if the waterproofing member 13 is attached to the AC adaptor 10 and the power terminal portion 7 with one of the end openings of the hollow portion 13a facing the power terminal portion 7 side or the other opening facing the power terminal portion 7 side, the position of the first bump portion 13b relative to the cylinder portion 10b and the position of the second bump portion 13c relative to the inner surface 7c do not change. Therefore, a user can attach the waterproofing member 12 to the AC adaptor 10 or to the power terminal portion 7 without being . aware of the orientation of the waterproofing member 12.

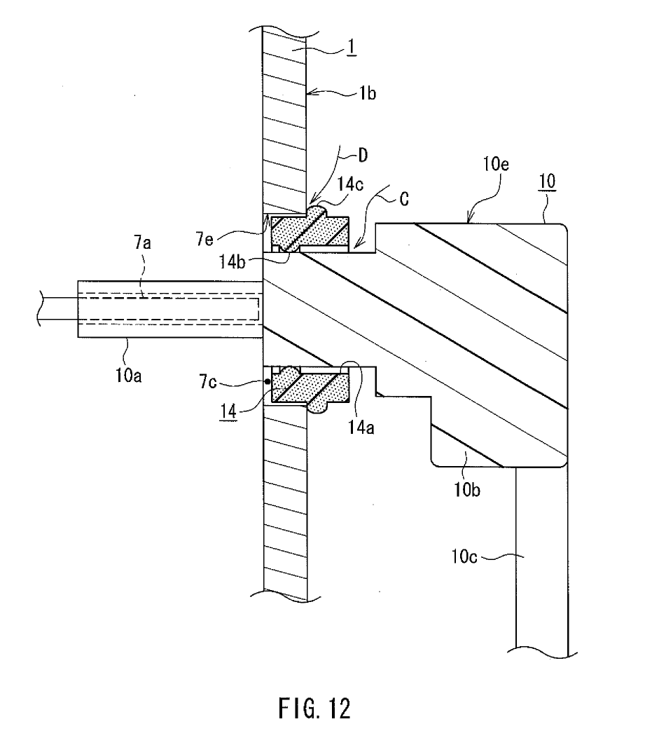

FIG. 12 shows an example where a first bump portion is disposed on the side closer to the terminal 7a of the power terminal portion 7 and a second bump portion is disposed on the side farther from the terminal 7a of the power terminal portion 7. In FIG. 12, the same components as those shown in FIG. 10 are denoted by the same reference numerals and the detailed descriptions thereof will not be repeated. Similarly to the waterproofing member 12 shown in FIG. 10, a waterproofing member 14 shown in FIG. 12 is made of a soft material and is formed in a substantially cylindrical shape. Referring to the waterproofing member 14, a first bump portion 14b is formed on a hollow portion 14a and a second bump portion 14c is formed on the external cylindrical surface of the waterproofing member 14. As shown in FIG. 12, the first bump portion 14b is formed such that it is situated on the side closer to the terminal 7a of the power terminal portion 7 when the waterproofing member 14 is attached at a right position. As shown in FIG. 12, the second bump portion 14c is formed such that it is situated on the side farther from the terminal 7a of the power terminal portion 7 than the first bump portion 14b when the waterproofing member 14 is attached at the correct position. In the state where the AC adaptor 10 is passed through the hollow portion 14a, the first bump portion 14b can come into contact with the cylinder portion 10b of the AC adaptor 10 or the cylinder portion 10b can be press-fitted to the first bump portion 14b. As shown in FIG. 12, the second bump portion 14c can come into contact with the side face 1b of the first enclosure 1. As shown in FIG. 12, the second bump portion 14c renders the hole 7c waterproof by coming into contact with the side face 1b. Since the waterproofing member 14 is made of a soft material, the second bump portion 14c can be inserted into the hole 7c to the position where it can come into contact with or can be press-fitted to the inner surface 7e of the hole 7c. It is preferable to insert the waterproofing member 14 into the hole 7c to the position where it can come into contact with or can be press-fitted to the inner surface 7e of the hole 7c because the certainty of waterproofing can be increased. As shown in FIG. 12, by press-fitting the AC adaptor 10 to the hollow portion 14a of the waterproofing member 14 and press-fitting the waterproofing member 14 to the hole 7c, the entry of a liquid in the direction indicated by the arrow C can be stopped by the first bump portion 14b. Further, the entry of a liquid in the direction indicated by the arrow D can be stopped by the second bump portion 14c. Consequently, the same effects as those of the present embodiment can be achieved. Furthermore, with the configuration shown in FIG. 12, there is no need to form a rib on the first enclosure 1, so that the configuration for allowing the attachment of the waterproofing member can be achieved without changing the shape of the first enclosure 1.

Each of the configurations which has been described with reference to FIGS. 10 to 12 and in which each of the second bump portions 12c, 13c and 14c is formed on the outer surface of the hollow portion is also advantageous in that a user can confirm visually the certainty of the connection between the AC adaptor 10 and the hole 7a.

The terminal 10a and the cylinder portion 10b in the present embodiment are examples of the terminal of the present application. The terminal 7a in the present embodiment is an example of the connection port of the present application. The power terminal portion 7, the rib 7b, the hole 7c, the inner surface 7e and the surface 8b in the present embodiment are examples of the connection area of the present application. The waterproofing members 11, 12, 13, 14 and 40 in the present embodiment are examples of the waterproofing member of the present application. The first bump portions 11b, 12b, 13b and 14b in the present embodiment are examples of the first bump portion of the present application. The second bump portions 11c, 12c, 13c and 14c in the present embodiment are examples of the second bump portion of the present application. The hollow portions 11a, 12a, 13a and 14a in the present embodiment are examples of the through hole of the present application.

### Embodiment 2

### 1. Configuration of Electronic Device

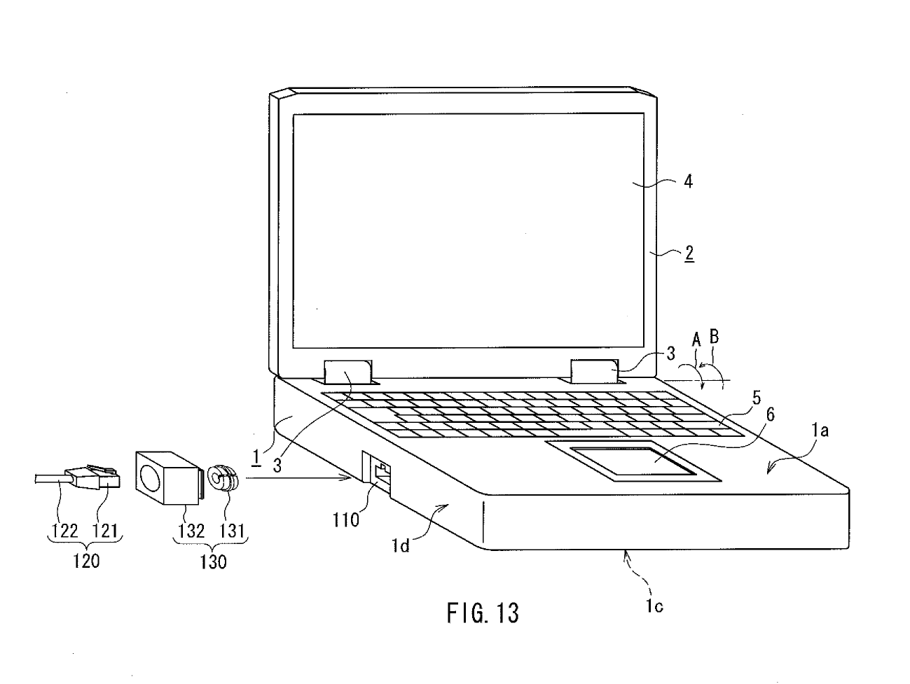

FIG. 13 is a perspective view showing appearances of a notebook computer, a waterproofing member and a LAN cable according to the present embodiment. Although a notebook computer is taken as an exemplary electronic device in the present embodiment, it can be any electronic device to which at least a connection device, such as any of various cables, can be connected. In addition to a notebook computer; examples of such electronic devices include a mobile phone terminal, a portable music player, a digital camera, a camcorder, and a portable game machine, which can be used in the outdoors and to which a connection device can be connected. Further, although a LAN (Local Area Network) cable is taken as an exemplary connection device in the present embodiment, it may be a power cable or a headphone cable and the form of a connection device is not limited. Also, a connection device does not have to have a special configuration for achieving a waterproofing capability.

As shown in FIG. 13, the notebook computer includes a first enclosure 1 and a second enclosure 2. The first enclosure 1 includes a circuit board on which a variety of electronic components are mounted, a hard disk drive, and the like. The second enclosure 2 includes a liquid crystal display 4. Each of the first enclosure 1 and the second enclosure 2 is supported rotatably by hinges 3. The hinges 3 each include a rotation shaft for rotatably supporting the first enclosure 1 and the second enclosure 2.

A keyboard 5 and a pointing device 6 are provided on a top face 1a of the first enclosure 1. A user types in a variety of characters with the keyboard 5. The pointing device 6 is a device operable to accept a touch operation performed by the user on its operating surface and to move a cursor displayed on the liquid crystal display 2a to a desired position.

A LAN port 110 is provided on a side face 1b of the first enclosure 1. A LAN cable 120 can be connected to the LAN port 110. By connecting a connector 121 of the LAN cable 120 to the LAN port 110, information can be exchanged between the notebook computer and the Local Area Network through the connector 121 and a cable portion 122. The LAN cable 120 can be connected directly to the LAN port 110 or it also can be connected to the LAN port 110 through a waterproofing member 130. When using the notebook computer in an environment where waterproofing capability is not required, such as indoors, it is preferable that the LAN cable 120 is directly connected to the LAN port 110. Further, when using the notebook computer in an environment where waterproofing capability is required, such as in the rain, the LAN port 110 can be rendered waterproof by connecting the LAN cable 120 to the LAN port 110 through the waterproofing member 130. Hereinafter, the configuration and the waterproofing capability of the waterproofing member 130 will be described in detail.

### 2. Configuration of Waterproofing Member 30

The waterproofing member 130 is composed of a first waterproofing member 131 and a second waterproofing member 132.

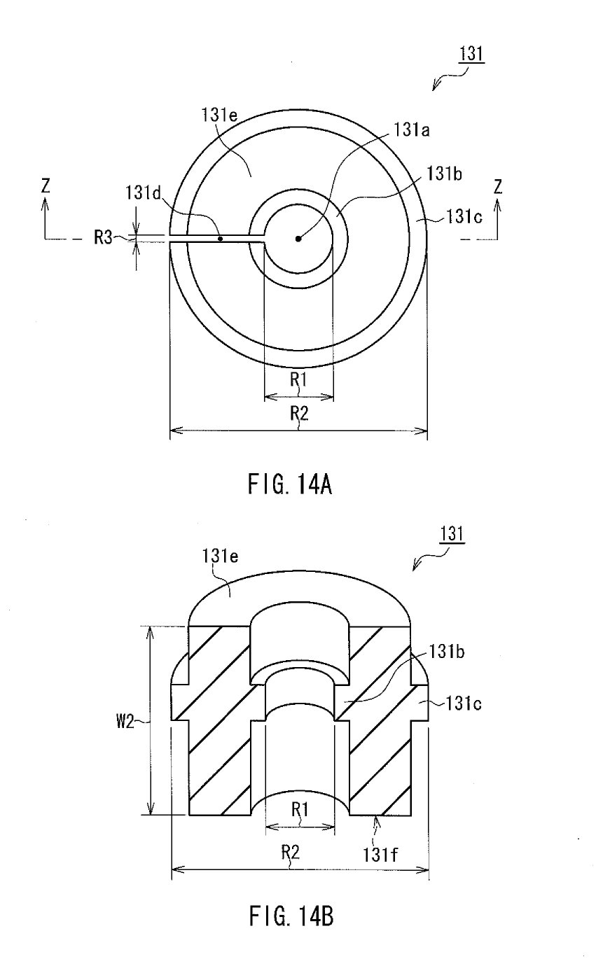

FIG. 14A is a plan view of the first waterproofing member 131. FIG. 14B is a perspective view of the first waterproofing member 131. In order to show the cross-section clearly, the first waterproofing member 131 is partially cut away (cut away at the Z-Z portion in FIG. 14A).

The first waterproofing member 131 includes a hollow portion 131a and has a substantially cylindrical shape. The hollow portion 131a penetrates the first member 131 from one end 131e to the other end 131f in the cylindrical axis direction.

The first waterproofing member 131 preferably is made of a restorable soft material that is elastically and compressively deformable (hereinafter referred to as elastically deformable) and is made of silicone rubber in the present embodiment as an example. A first bump portion 131b is formed on the inner surface of the hollow portion 131a. A second bump portion 131c is formed on the outer surface of the first waterproofing member 131.

A slit 131d is formed on a part of the first waterproofing member 131 in the circumference direction. The slit 131d is formed seamlessly from the one end face 131e to the other end face 131f of the first waterproofing member 131 in the cylindrical axis direction.

The first bump portion 131b is formed seamlessly on the inner surface of the hollow portion 131a in the circumference direction except on the slit 131d.

The second bump portion 131c is formed seamlessly on the outer surface of the first waterproofing member 131 in the circumference direction except on the slit 131d.

The entire first waterproofing member 131 does not have to be made of an elastically deformable soft material having restorability. For the first waterproofing member 131, as long as the first bump portion 131b and the second bump portion 131c are made of an elastically deformable material, other parts may be made of a soft material such as a flexible material or an elastomer material having rubber elasticity.

In FIGS. 14A and 14B, R1 denotes the inside diameter of the first bump portion 131b, R2 denotes the outside diameter of the second bump portion 131c and R3 denotes the width of the slit 131d.

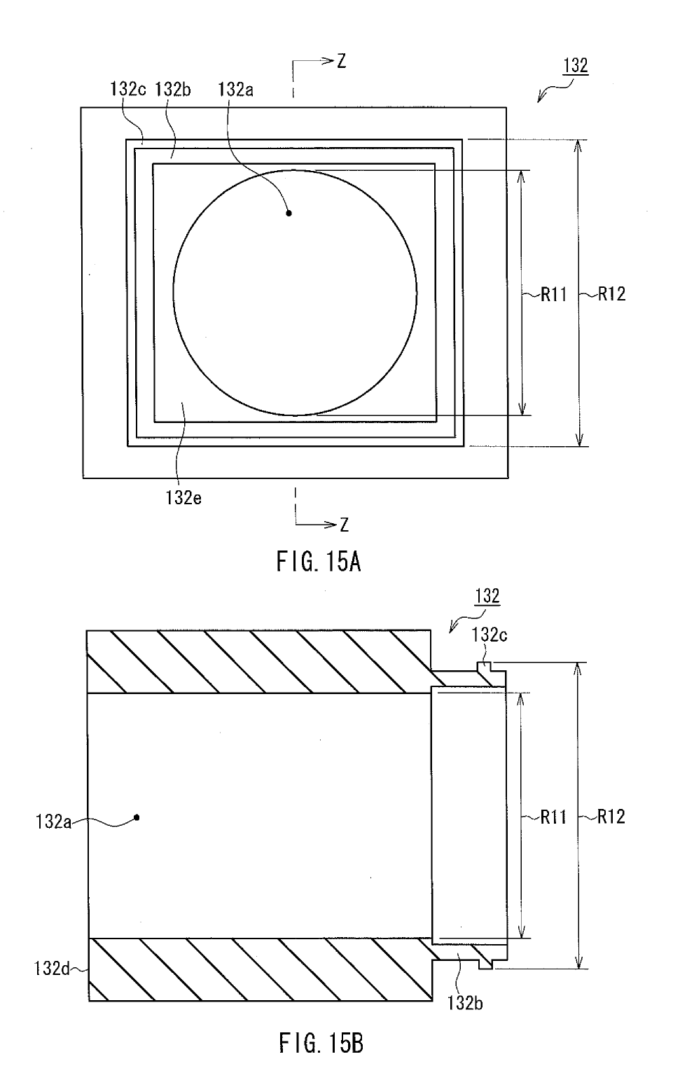

FIG. 15A is a plan view of the second waterproofing member 132. FIG. 15B is a cross-sectional view of the Z-Z portion in FIG. 15A.

The second waterproofing member 132 includes a hollow portion 132a and has a substantially prismatic shape. The hollow portion 132a penetrates the second waterproofing member 132d from one end 132d to the other end 132e. The hollow portion 132a has an inside diameter R11 through which at least the connector 121 of the LAN cable 120 can be passed.

The second waterproofing member 132 preferably is made of a restorable soft material having a higher degree of hardness than the first waterproofing member 131, such as an internally plasticized resin or an elastomer resin having a three-dimensional mesh structure. In the present embodiment, the second waterproofing member 132 is made of a polybutylene terephthalate resin material as an example.

A fit portion 132b is formed at the other end 132e of the second waterproofing member 132. The fit portion 132b has an outside diameter R12 that can be press-fitted to a concave portion 111 (described later) formed around the LAN port 110 (see FIG. 13). That is, a third bump portion 132c is formed on the side faces of the fit portion 132b. When opposing planes of the second waterproofing member 132 are pressed against each other, the second waterproofing member 132 deforms flexibly. The third bump portion 132c is formed seamlessly on the four adjacent side faces of the fit portion 132b.

The entire second waterproofing member 132 does not have to be made of the above-mentioned soft material as long as the third bump portion 132c is made of the soft material.

### 3. Attachment of Waterproofing Member 301

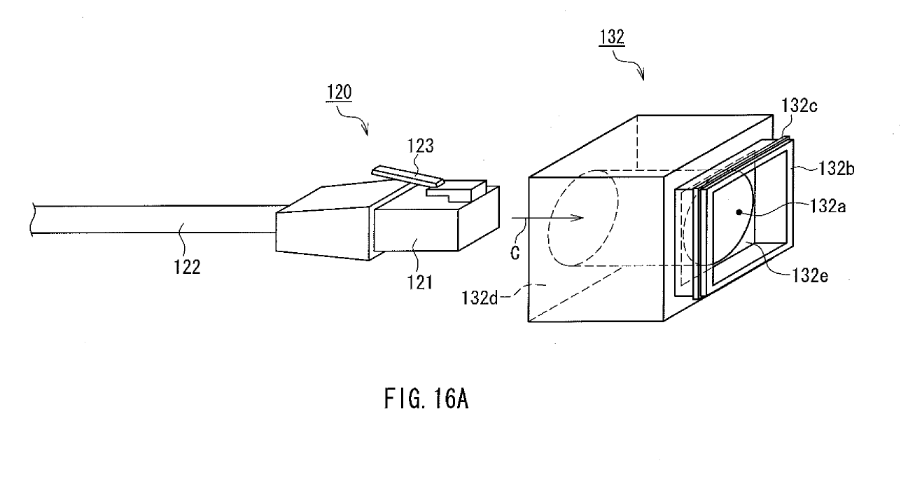

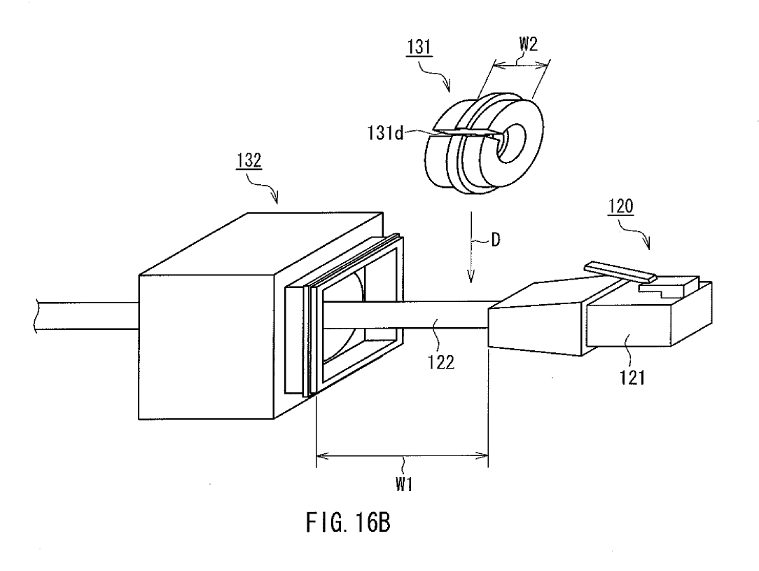

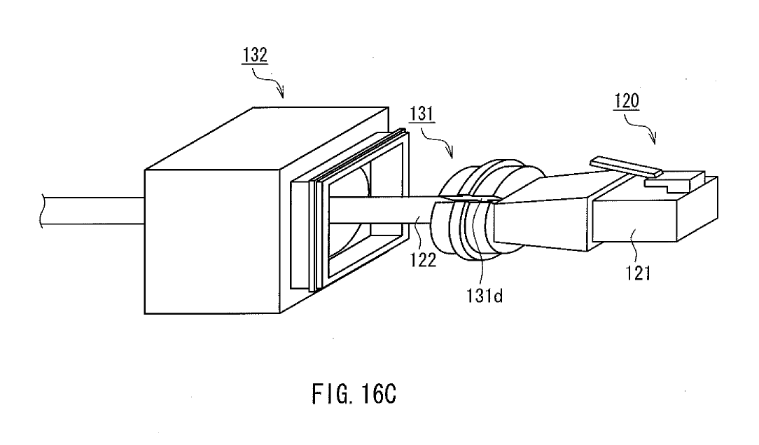

FIGS. 16A to 16C are transitional perspective views showing attachment of the waterproofing member 130 to the LAN cable 120.

The waterproofing member 130 is attached to the LAN cable 120 as follows. First, as shown in FIG. 16A, the LAN cable 120 is passed through the hollow portion 132a of the second waterproofing member 132. Specifically, the LAN cable 120 is inserted into the hollow portion 132a from the one end 132d of the second waterproofing member 132 and is pulled out from the other end 132e of the hollow portion 132a. The hollow portion 132a has such an inside diameter that at least the connector 121 of the LAN cable 120 can be passed therethrough. FIG. 16B shows a state where the LAN cable 120 is passed through the hollow portion 132a of the second waterproofing member 132. In the state shown in FIG. 16B, the second waterproofing member 132 can be displaced in the direction along the cable portion 122.

Next, as shown in FIG. 16B, the first waterproofing member 131 is attached to the cable portion 122 of the LAN cable 120.

Specifically, first, the second waterproofing member 132 or the LAN cable 120 is displaced to form a clearance W1 between the second waterproofing member 132 and the connector 121. The clearance W1 needs to be at least larger than a length W2 (the length between the one end 131e and the other end 131f) of the first waterproofing member 131. The cable portion 122 is partially present in the clearance W1.

Subsequently, the first waterproofing member 131 is deformed such that the width R3 (see FIG. 14A) of the slit 131d of the first waterproofing member 131 becomes at least larger than the thickness of the cable portion 122. Specifically, a user holds the first waterproofing member 131 in the vicinity of the slit 131d with the fingers to deform the first waterproofing member 131 continuously in the direction in which the width R3 of the slit 131d widens. Because the first waterproofing member 131 is made of an elastically deformable material, it can be deformed in the above-described manner.

Next, the first waterproofing member 131 is displaced in the direction indicated by the arrow D to place a part of the cable portion 122 in the hollow portion 131a through the slit 131d whose width has been widened. In other words, the first waterproofing member 131 is put onto the cable portion 122 between the second waterproofing member 132 and the connector 121.

Thereafter, the user releases the first waterproofing member 131 from his fingers to end the continuous widening of the slit 131d. As a result, the first waterproofing member 131 returns to its original shape, so that the first waterproofing member 131 can be held on the cable portion 122.

FIG. 16C shows a state where the first waterproofing member 131 is held on the cable portion 122.

The “original shape” of the first waterproofing member 131 refers to a shape where no external pressure is applied to the first waterproofing member 131, and at this time, the inside diameter R1 of the hollow portion 131a is preferably equal to or smaller than the thickness of the cable portion 122. Given that the width R3 of the slit 131d is smaller than the thickness of the cable portion 122 when the first waterproofing member 131 is in its original shape, in other words, given that the width of the slit 131d in FIG. 16C is R3a, the slit 131d preferably has the relationship R3a≧R3 because the first waterproofing member 131 does not depart from the cable portion 122 when the first waterproofing member 131 is held on the cable portion 122, thereby enhancing the ease of attachment of the waterproofing member 130.

Then, the LAN cable 120 is connected to the LAN port 110 (see FIG. 13) provided on the notebook computer.

In the present embodiment, although the LAN cable 120 is connected to the LAN port 110 after putting the first waterproofing member 131 and the second waterproofing member 132 onto the LAN cable 120, the following steps also may be performed. That is, first, the second waterproofing member 132 is put onto the LAN cable 120, then, the LAN cable 120 is connected to the LAN port 110, and finally, the first waterproofing member 131 is put onto the LAN cable 120.

Next, the first waterproofing member 131 put on the LAN cable 120 is press-fitted to the hollow portion 132a of the second waterproofing member 132. Although the details will be described later, since the outside diameter R2 of the first waterproofing member 131 (see FIG. 14B) is larger than the inside diameter R11 of the hollow portion 132a (see FIG. 15B), the first waterproofing member 131 elastically deforms when it is press-fitted to the hollow portion 132a.

When the first waterproofing member 131 is being press-fitted to the hollow portion 132a of the second waterproofing member 132, the width R3b of the slit 131d is preferably 0. That is, it is preferable to form the width of the slit 131d, the inside diameter R1 of the first bump portion 131b present in the hollow portion 131a of the first waterproofing member 131 and the outside diameter R2 of the second bump portion 131c such that the width R3b becomes 0.

Afterwards, the first waterproofing member 131 is displaced in the direction indicated by the arrow D along the cable portion 122 to press-fit the fit portion 132b to the concave portion 111 in the vicinity of the LAN port 110. Although the details will be described later, since the outside diameter R12 of the third bump portion 132c (see FIG. 15B) is larger than the inside diameter R21 of the concave portion 111 (described later), at least the third bump portion 132c of the fit portion 132b elastically deforms when it is press-fitted to the concave portion 111.

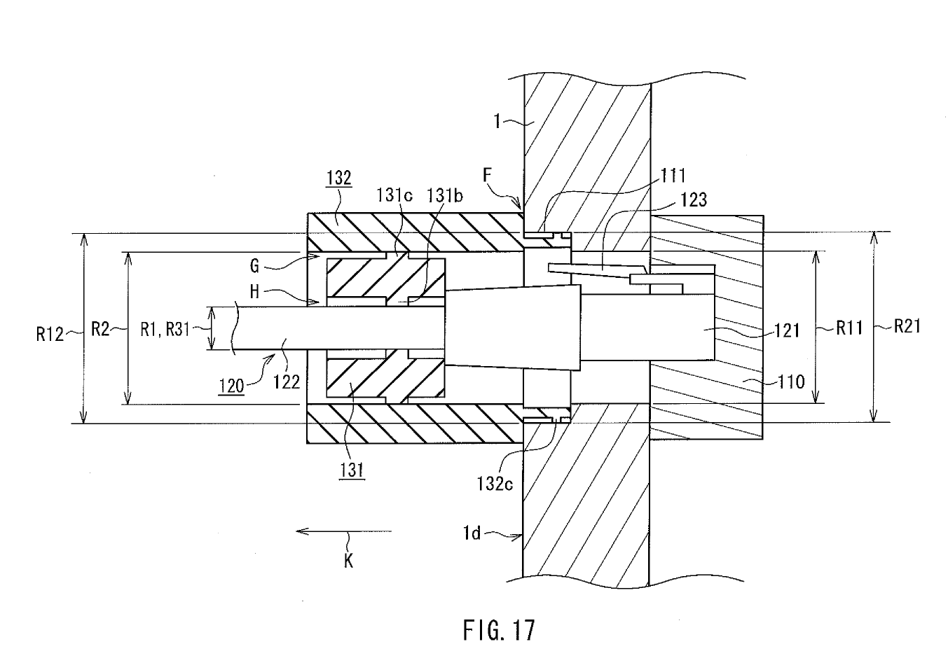

FIG. 17 is a cross-sectional view showing a state where the second waterproofing member 132 is press-fitted to the concave portion 111. As shown in FIG. 17, when the second waterproofing member 132 is press-fitted to the concave portion 111, the third bump portion 132c of the second waterproofing member 132 is in intimate contact with the interior wall of the concave portion 111. Since the outside diameter R12 of the third bump portion 132c and the inside diameter R21 of the concave portion 111 have the relationship R21≦R12, the tip of the third bump portion 132c is in intimate contact with the interior wall of the concave portion 111 and the third bump portion 132c is in intimate contact with the interior wall of the concave portion 111 in an encircling manner. Consequently, the advance of a liquid or the like in the direction indicated by the arrow F through a gap between the first enclosure 1 and the second waterproofing member 132 is stopped by the third bump portion 132c, so that the entry into the LAN port 110 can be prevented.

By setting the outside diameter R12 of the third bump portion 132c and the inside diameter R21 of the concave portion 111 to have the relationship “R21<R12”, the third bump portion 132c elastically deforms when the second waterproofing member 132 is press-fitted to the concave portion 111. As a result, the intimate contact between the third bump portion 132c and the interior wall of the concave portion 111 can be enhanced and the certainty of waterproofing can be increased.

Further, when the outside diameter R12 of the third bump portion 132c and the inside diameter R21 of the concave portion 111 are set to have the relationship “R21<R12”, the third bump portion 132c elastically deforms when the second waterproofing member 132 is press-fitted to the concave portion 111. Therefore, the outside diameter (outside diameter R12 shown in FIG. 17) of the third bump portion 132c in the press-fitted state becomes smaller than the outside diameter (outside diameter R12 shown in FIG. 15B) of the third bump portion 132c not in the press-fitted state.

Further, the first waterproofing member 131 is press-fitted to the hollow portion 132a of the second waterproofing member 132. At this time, the outside diameter R2 of the second bump portion 131c of the first waterproofing member 131 and the inside diameter R11 of the hollow portion 132a have the relationship R11≦R2. Thus, the first waterproofing member 131 compressively deforms within the hollow portion 132a. Specifically, when the first waterproofing member 131 is press-fitted to the hollow portion 132a, its external cylindrical surface is pressed, so that the opposing end faces forming the slit 131d come into intimate contact with each other and are compressively deformed until the slit 131d is gone. Furthermore, when the first waterproofing member 131 is press-fitted to the hollow portion 132a, the second bump portion 131c elastically deforms to come into intimate contact with the interior wall of the hollow portion 132a. Consequently, the advance of a liquid or the like in the direction indicated by the arrow G through a gap between the first waterproofing member 131 and the second waterproofing member 132 is stopped by the second bump portion 131c, so that the entry into the LAN port 110 can be prevented.

Since the second bump portion 131c elastically deforms when the first waterproofing member 131 is press-fitted to the hollow portion 132a, the outside diameter (outside diameter R2 shown in FIG. 17) of the second bump portion 131c in the press-fitted state becomes smaller than the outside diameter (outside diameter R2 shown in FIG. 14A) of the second bump portion 131c not in the press-fitted state.

Further, when the first waterproofing member 131 is press-fitted to the hollow portion 132a, the first waterproofing member 131 compressively deforms and the first bump portion 131b comes into intimate contact with the cable portion 122 of the LAN cable 120. Since the inside diameter R1 of the first bump portion 131b and the thickness R31 of the cable portion 122 have the relationship R1≦R31, the tip of the first bump portion 131b comes into intimate contact with the surface of the cable portion 122 and the first bump portion 131b comes into intimate contact with the surface of the cable portion 122 in an encircling manner. Consequently, the advance of a liquid or the like in the direction indicated by the arrow H through a gap between the first waterproofing member 131 and the cable portion 122 is stopped by the first bump portion 131c, so that the entry into the LAN port 110 can be prevented.

By setting the inside diameter R1 of the first bump portion 131b and the thickness R31 of the cable portion 122 to have the relationship “R1<R31”, the first bump portion 131b elastically deforms when the first waterproofing member 131 is press-fitted to the hollow portion 132a. As a result, the intimate contact between the first bump portion 131b and the interior wall of the hollow portion 132a can be enhanced and the certainty of waterproofing can be increased.

Further, when the inside diameter R1 of the first bump portion 131b and the thickness R31 of the cable portion 122 are set to have the relationship “R1<R31”, the first bump portion 131b elastically deforms when the first waterproofing member 131 is press-fitted to the hollow portion 132a. Therefore, the inside diameter (outside diameter R1 shown in FIG. 17) of the first bump portion 131b in the press-fitted state becomes larger than the inside diameter (outside diameter R1 shown in FIG. 14A) of the first bump portion 131b not in the press-fitted state.

In the present embodiment, although the second waterproofing member 132 is displaced in the direction indicated by the arrow D after press-fitting the first waterproofing member 131 to the hollow portion 132a, the following steps may be performed. That is, after displacing the first waterproofing member 131 in the direction indicated by the arrow D until the first waterproofing member 131 comes into contact with the connector 121, the second waterproofing member 132 is displaced in the direction indicated by the arrow D and then the first waterproofing member 131 is press-fitted to the hollow portion 132a.

When removing the LAN cable 120 and the waterproofing member 130 from the LAN port 110 in the state shown in FIG. 17, first, the second waterproofing member 132 is displaced in the direction indicated by the arrow K to detach the fit portion 132b from the concave portion 111. Since a hook 123 is in engagement with the LAN port 110, the LAN cable 120 remains connected to the LAN port 110. Further, when displacing the second waterproofing member 132 in the direction indicated by the arrow K, the first waterproofing member 131 is displaced in the direction indicated by the arrow K together with the second waterproofing member 132 while being press-fitted to the hollow portion 132a or is detached from the hollow portion 132a and remains at the position shown in FIG. 17.

Next, the connector 121 is removed from the LAN port 110 by deforming the hook 123 to disengage it from the LAN port 110. As a result, the LAN cable 120 is detached from the LAN port 110.

Then, the first waterproofing member 131 is removed from the LAN cable 120. Specifically, the first waterproofing member 131 is deformed until the width R3 of the slit 131d becomes larger than the thickness R31 of the cable portion 122, and the first waterproofing member 131 is detached from the LAN cable 120 through the slit 131d.

Subsequently, the second waterproofing member 132 is removed from the LAN cable 120. Specifically, the second waterproofing member 132 can be removed from the LAN cable 120 by displacing the LAN cable 120 in the direction indicated by the arrow K to pass the connector 121 through the hollow portion 132a.

Through the steps described above, the LAN cable 120 and the waterproofing member 130 can be removed from the LAN port 110. After the removal of the LAN cable 120 from the LAN port 110, the first waterproofing member 131 and the second waterproofing member 132 may be held on the cable portion 122 of the LAN cable 120 so that a loss of the waterproofing members can be prevented.

The hollow portion 131a of the first waterproofing member 131 also can be formed to have a shape and an inside diameter compatible with LAN cables including cable portions with various cross-sections such as flat and various outside diameters.

### 4. Effects of Embodiment, Etc.

According to the present embodiment, the entry of a liquid or like into the LAN port 110 from outside can be prevented by brining the first waterproofing member 131 into intimate contact with the LAN cable 120, press-fitting the first waterproofing member 131 to the hollow portion 132a of the second waterproofing member 132, and press-fitting the second waterproofing member 132 to the concave portion 111.

Furthermore, since there is no need to change the outside shape of the LAN cable 120 to achieve the waterproof structure, the waterproof structure can be achieved without incurring a significant cost increase. Furthermore, because a conventional LAN cable can be used, the waterproofing member according to the present embodiment excels in general versatility.

Further, because the waterproofing member 130 is attachable to and detachable from the LAN cable 120, the waterproofing member 130 can be removed from the LAN cable 120 when there is no need to form the waterproof structure. Accordingly, when there is no need to form the waterproof structure such as within doors, it is possible to prevent the LAN cable 120 from being bulky.

In the present embodiment, the first bump portion 131b, the second bump portion 131c and the third bump portion 132c are provided. However, each of the bump portions is not essential as long as the first waterproofing member 131 and the second waterproofing member 132 come into intimate contact with each other the first waterproofing member 131 and the cable portion 122 come into intimate contact with each other and the second waterproofing member 132 and the concave portion 111 come into close contact with each other to render the LAN port 110 waterproof.

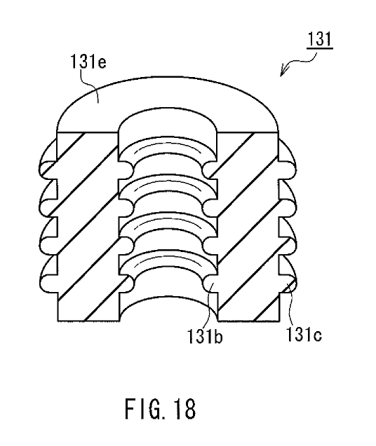

In the present embodiment, although the first bump portion 131b, the second bump portion 131c and the third bump portion 132c are each provided in one area, they may be each provided in a plurality of areas. FIG. 18 is a cross-sectional view of the first waterproofing member 131 where the first bump portions 131b and the second bump portions 131c are each formed in four areas. For example, as shown in FIG. 18, as a result of having a plurality of the first bump portions 131b and a plurality of the second bump portions 132c, the waterproofness between the first waterproofing member 131 and the LAN cable 120 and the waterproofness between the first waterproofing member 131 and the second waterproofing member 132 can be improved further.

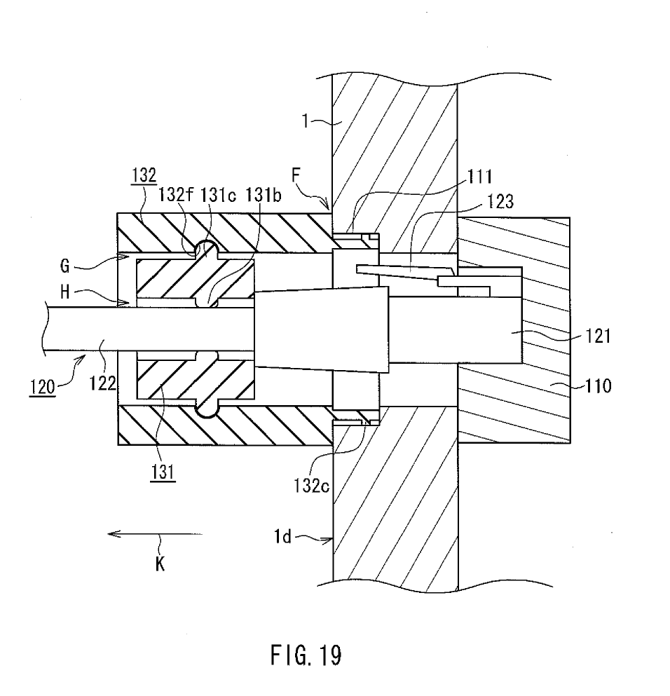

As shown in FIG. 19, it is preferable to form a concave portion 132f on the internal wall of the hollow portion 132a of the second waterproofing member 132. As a result of having such a configuration, when fitting the first waterproofing member 131 to the hollow portion 132a, the second bump portion 131c can be fitted to the concave portion 132f to reduce a relative misalignment between the first waterproofing member 131 and the second waterproofing member 132.

That is, at the time of fitting the first waterproofing member 131 to the hollow portion 132a and displacing the first waterproofing member 131 in the direction indicated by the arrow D to fit the second waterproofing member 132 to the concave portion 111, when friction between the first bump portion 131b and the surface of the cable portion 122 is larger than that between the second bump portion 131c and the interior wall of the hollow portion 132a, the first waterproofing member 131 may depart from the hollow portion 132a from the one end 132d side. From this reason, by forming the concave portion 132f on the interior wall of the hollow portion 132a and fitting the second bump portion 131c to the concave portion 132f, a relative misalignment between the first waterproofing member 131 and the second waterproofing member 132 is less likely to occur when displacing the second waterproofing member 132 in the direction indicated by the arrow D.

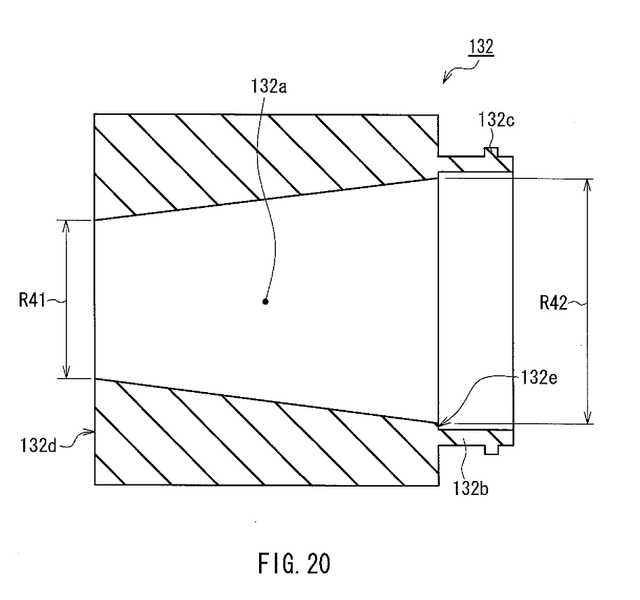

In the present embodiment, the hollow portion 132a of the second waterproofing member 132 has a constant inside diameter from the one end 132d to the other end 132e. However, as shown in FIG. 20, by forming the hollow portion 132a such that the inside diameter R41 on the one end 132d side and the inside diameter R42 on the other end 132e side have the relationship R41<R42, the first waterproofing member 131 can be press-fitted to the hollow portion 132a with certainty.

In the present embodiment, although the first bump portion 131b and the second bump portion 131c are formed on the hollow portion 131a and on the outer surface of the first waterproofing member 131 respectively. in one area, at least one of them may be formed in a plurality of areas.

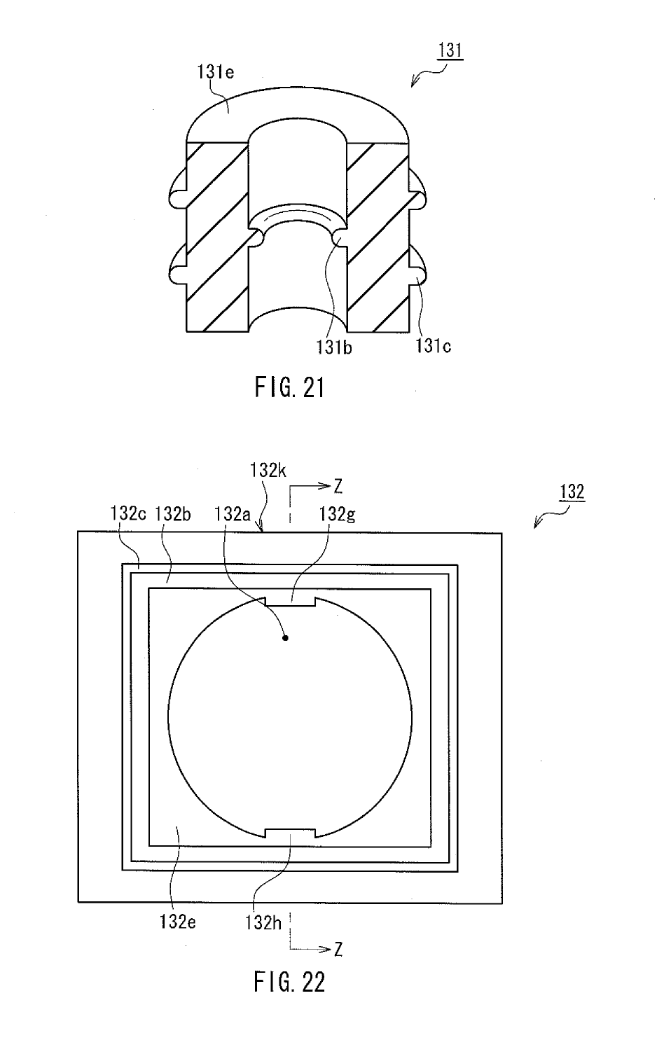

FIG. 21 is a cross-sectional view showing a modified example of the first waterproofing member 131. The first bump portion 131b shown in FIG. 21 is provided on the interior surface of the hollow portion 131a in one area. The second bump portions 131c are provided on the circumferential surface of the first waterproofing member 131 in two areas. The first bump portion 131b shown in FIG. 21 is formed between the two second bump portions 131c in the axis direction of the first waterproofing member 131. As a result of the wall of the first waterproofing member 131 present between the opposing bump portions being bent, the intimate contact between the first bump portion 131b and the cable portion 122 and the intimate contact between the second bump portions 131c and the interior wall of the hollow portion 132a of the second waterproofing member 132 can be improved.

The configuration is not limited to the one shown in FIG. 21. The same effect can be achieved by providing two first bump portions 131b and one second bump portion 131c and placing the second bump portion 131c between the two first bump portions 131 in the axis direction of the first waterproofing member 131.

In the present embodiment, when removing the LAN cable 120 and the waterproofing member 130 from the notebook computer, the LAN cable 120 is removed after removing the waterproofing member 130. However, there is a configuration that allows the removal of the LAN cable 120 and the waterproofing member 130 at the same time.

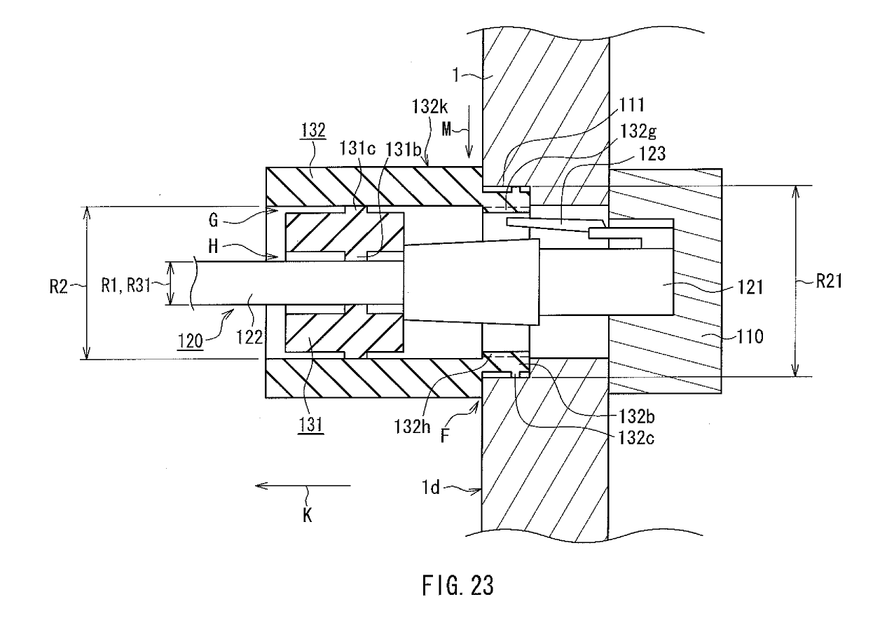

FIG. 22 is a side view showing a modified example of the second waterproofing member 132. FIG. 23 is a cross⁻sectional view showing a state where the waterproofing member 130 including the second waterproofing member 132 (modified example) and the LAN cable 120 are attached to the notebook computer.

The second waterproofing member 132 shown in FIGS. 22 and 23 includes a fourth bump portion 132g and a fifth bump portion 132h on the inner surface of the fit portion 132b. The forth bump portion 132g and the fifth bump portion 132h oppose each other through the hollow portion 132a. As shown in FIG. 23, the fourth bump portion 132g is situated above the hook 123 of the LAN cable 120 when the second waterproofing member 132 is attached to the notebook computer.

When removing the LAN cable 120 and the waterproofing member 130 from the notebook computer in such a configuration, by pressing a top face 132k of the second waterproofing member 132 in the direction indicated by the arrow M, the second waterproofing member 132 deforms elastically in the direction indicated by the arrow M and the vicinity of the fourth bump portion 132g on the fit portion 132b is displaced in the direction indicated by the arrow M. By displacing the vicinity of the fourth bump portion 132g on the fit portion 132b to a certain position, the fourth bump portion 132g presses the hook 123 in the direction indicated by the arrow M and the hook 123 is disengaged from the LAN port 110.

Next, while the hook 123 is in disengagement from the LAN port 110, the second waterproofing member 132 is displaced in the direction indicated by the arrow K. Consequently, the LAN cable 120 and the first waterproofing member 131 can be displaced in the direction indicated by the arrow K. As a result, the LAN cable 20 and the waterproofing member 30 can be removed from the notebook computer at the same time.

In the present embodiment, although the two opposing surfaces that form the slit 31d are planar and are perpendicular to the one end 31e and the other end 31f, they do not need to be planar. When the two opposing surfaces that form the slit 31d respectively have a projection and a depression that engage with each other, warping caused by fitting or displacement of the slit 31d of the first waterproofing member 31 can be achieved more firmly at the time of press-fitting the first waterproofing member 31 to the hollow portion 32a of the second waterproofing member 32, so that the waterproofing capability can be improved.

Further, the two opposing surfaces that form the slit 31d may be tilted relative to the one end 31e and the other end 31f at a certain angle (e.g., 45°). By having such a configuration, when the first waterproofing member 31 is press-fitted to the hollow portion 32a of the second waterproofing member 32, the contact area between the two opposing surfaces that form the slit 31d increases, so that warping caused by fitting or displacement of the slit 31d of the first waterproofing member 31 can be achieved more firmly, and the waterproofing capability can be improved.

The waterproofing member 30 in the present embodiment is an example of the waterproofing member of the present application. The first waterproofing member 31 in the present embodiment is an example of the first waterproofing member of the present application. The second waterproofing member 32 in the present embodiment is an example of the second waterproofing member of the present application. The first bump portion 31b in the present embodiment is an example of the first bump portion of the present application. The second bump portion 31c in the present embodiment is an example of the second bump portion of the present application. The third bump portion 32c in the present embodiment is an example of the third bump portion of the present application. The hollow portion 31a in the present embodiment is an example of the first hole of the present application. The hollow portion 32a in the present embodiment is an example of the second hole of the present application. The convex portion 11 in the present embodiment is an example of the convex portion of the present embodiment. The LAN port in the present embodiment is an example of the connection port of the present application. The LAN cable 20 in the present embodiment is an example of the cable of the present embodiment.

The present application relates to a waterproofing member for a terminal provided for an electronic device.

The invention may be embodied in other forms without departing from the spirit of essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A waterproofing member attachable to a connection area in which a terminal is connected to a connection port, the waterproofing member comprising:
a first bump portion that is erected seamlessly and can come into contact with a periphery of the terminal;
a second bump portion that can come into contact with the connection port; and
a through hole through which the connection port can be passed,
wherein when the terminal is connected to the connection port, the waterproofing member conceals the terminal and the second bump portion is in intimate contact with the connection port.

2. The waterproofing member according to claim 1, wherein the first bump portion and the second bump portion are made of a soft material.

3. A waterproofing member attachable to and detachable from a concave portion formed in the vicinity of a connection port to which a terminal provided for a cable is connected, the waterproofing member comprising:
a first waterproofing member that includes a first hole through which the terminal can be passed and can be press-fitted to the concave portion; and
a second waterproofing member that includes a second hole through which the cable can be passed and can be press-fitted to the first hole,
wherein by passing the cable through the first hole, press-fitting the first waterproofing member to the second hole and press-fitting the second waterproofing member to the concave portion, the second waterproofing member and the concave portion come into intimate contact with each other, the first waterproofing member and the second waterproofing member come into intimate contact with each other, and the first waterproofing member and the cable come into intimate contact with each other.

4. The waterproofing member according to claim 3, wherein the first waterproofing member includes a first elastically deformable bump portion in an area that can come into intimate contact with the cable.

5. The waterproofing member according to claim 3, wherein the first waterproofing member includes a second elastically deformable bump portion in an area that can come into intimate contact with the second hole.

6. The waterproofing member according to claim 3, wherein the second waterproofing member includes a third elastically deformable bump portion in an area that can come into intimate contact with the concave portion.

7. The waterproofing member according to claim 3, wherein the first waterproofing member includes a second elastically deformable bump portion in an area that can come into contact with the second hole, and
the second waterproofing member includes in the second hole a concave portion to which the second bump portion is fitted.

8. The waterproofing member according to claim 3, wherein one opening and the other opening of the second hole have different inside diameters.
